(19) United States
(12) Patent Application Publication
(10) Pub. No.: US 2025/0344633 A1
(43) Pub. Date: Nov. 13, 2025

(54) PNEUMATIC FERTILIZER SPREADER AND METHOD FOR SPREADING GRANULAR AGRICULTURAL SPREADING MATERIAL

(71) Applicant: HORSCH LEEB Application Systems GmbH, Landau an der Isar (DE)

(72) Inventor: Theodor LEEB, Landau an der Isar (DE)

(73) Assignee: HORSCH LEEB Application Systems GmbH, Landau an der Isar (DE)

(21) Appl. No.: 19/200,304

(22) Filed: May 6, 2025

(30) Foreign Application Priority Data
May 8, 2024 (DE) 10 2024 112 921.2

(51) Int. Cl. A01C 15/04

(52) U.S. Cl. CPC A01C 15/04

(57) ABSTRACT

There is a pneumatic fertilizer spreader for spreading granular agricultural material on agricultural land. The spreader has a chassis carrying components of the spreader and a distributor boom, which extends transversely to the direction of travel (FR), and is mounted height-adjustably on the chassis. A plurality of distribution lines with distribution elements are attached to a distributor boom, which has a metering device designed for metering a defined quantity of spreading material from a storage container into the distribution lines and a flow-generating device. To increase the maximum amount of granular spreading material that can be spread, the flow-generating device is designed to generate, by a respective connection, a feed air flow in the distribution lines for transporting the spreading material therealong and a greater positive pressure in the storage container than atmospheric pressure. There is also a method for spreading granular agricultural material.

### CROSS-REFERENCE TO A RELATED APPLICATION

The present application claims priority from Germany Application No. DE 10 2024 112 921.2, filed May 8, 2024, which is incorporated herein by reference in its entirety.

### FIELD OF THE DISCLOSURE

The disclosure relates to a pneumatic fertilizer spreader for spreading granular agricultural spreading material on agricultural productive land. The disclosure also relates to a method for spreading granular agricultural spreading material on agricultural productive land.

### DESCRIPTION OF THE RELATED ART

Pneumatic fertilizer spreaders are known in the prior art. In pneumatic fertilizer spreaders of this type, the granular agricultural spreading material to be distributed in each case, e.g., granular fertilizer, is metered from a storage container by metering devices assigned to the storage container into an air volume flow and conveyed by means of said air volume flow from the storage tank along a multiplicity of distribution lines arranged on a distributor boom. Distribution elements, for example, baffle plates, are in each case attached to the distribution lines. The spreading material is conveyed towards the distribution elements by means of the air volume flow and then distributed over the entire area by means of spreading fans thus produced.

In prior art pneumatic fertilizer spreaders, an injector is arranged downstream of the metering devices, the injector being designed to introduce the spreading material, which is metered by means of the metering devices, into the air volume flow by the generation of a negative pressure in the transfer region. However, the maximum possible amount of spreading material conveyed by means of injectors of this type (e.g., Venturi nozzles) is limited since a sufficient negative pressure can be generated only until a maximum amount of spreading material, which depends on the design of the injector, is reached. Therefore, large amounts of spreading material cannot be spread using pneumatic fertilizer spreaders known from the prior art. Thus, for example, two or more passes over the productive land have to be carried out in order to achieve the required amounts.

### SUMMARY OF THE DISCLOSURE

It would be desirable to eliminate the above-described disadvantages of prior art pneumatic fertilizer spreaders. In particular, it would be desirable to increase the maximum amount of granular spreading material that can be spread by means of a pneumatic fertilizer spreader.

### SUMMARY OF THE DISCLOSURE

Advantages are achieved by a pneumatic fertilizer spreader for spreading granular agricultural spreading material. Advantageous embodiments and developments of the disclosure are disclosed in the claims and in the description below with partial reference to the figures.

According to a first aspect of the disclosure, a pneumatic fertilizer spreader, for spreading granular agricultural spreading material (e.g. granular fertilizer) on agricultural productive land, is provided.

The pneumatic fertilizer spreader can be designed as a fertilizer spreader which is self-propelling, as a fertilizer spreader pulled by means of a towing vehicle, or as a fertilizer spreader attached to a towing vehicle. In addition, the fertilizer spreader can be designed as an autonomous or partially autonomous vehicle and/or can be attached (e.g. by means of three-point suspension) to a vehicle designed in such a way.

The fertilizer spreader comprises a chassis carrying components of the fertilizer spreader. The chassis is preferably formed by a frame construction and/or carrier construction.

The fertilizer spreader comprises a distributor boom, which extends transversely to the direction of travel and is mounted height-adjustably on the chassis, wherein the distributor boom has a central part and side arms pivotably mounted on the central part, and wherein a plurality of distribution lines with distribution elements (e.g. baffle plates) are attached to the distributor boom. The distribution lines each extend to different lengths, starting from the central part, along the direction of longitudinal extent of the distributor boom. The distribution lines are each arranged at regular distances from one another. The distance between the distribution elements is, for example, 1 metre or 2 metres or 3 metres or the like. The respective length of the distribution lines of the distribution elements also varies in accordance with the arrangement of the distribution elements.

In addition, the fertilizer spreader comprises a metering device, which is designed for metering a defined quantity of spreading material from a storage container into the distribution lines. The amount of spreading material can be defined manually, e.g. by an operator. Alternatively or in addition, the amount of spreading material can be defined by means of a sensor arrangement attached to the fertilizer spreader, which sensor arrangement is designed to detect a crop on agriculturally productive land. Alternatively or in addition, the amount can be predetermined by an application map.

In order to pneumatically convey the spreading material, e.g. along the distribution lines, the fertilizer spreader according to the disclosure furthermore comprising a flow-generating device.

In order to provide a pneumatic fertilizer spreader, by means of which an increase in the maximum amount of granular spreading material which can be spread is achieved, it is provided according to the disclosure that the flow-generating device is designed to generate, by means of a respective connection, a feed air flow in the distribution lines for transporting the spreading material along the distribution lines, and a greater positive pressure than atmospheric pressure in the storage container.

As a result of the charging of the storage container with positive pressure, the effect is expediently achieved according to the disclosure that the spreading material can be conveyed from the storage container approximately in freefall into the distribution lines by the metering device, as a result of which pressure influences no longer have any limiting effects on the conveying of the spreading material and therefore the maximum amount of spreading material which can be spread is essentially limited exclusively by the cross sections of the metering device and the distribution lines.

The fertilizer spreader according to the disclosure is designed in particular as a pneumatic fertilizer spreader, i.e. is designed as a fertilizer spreader in which the spreading material is conveyed by a pneumatic flow, e.g. a feed air flow. Even if, for the sake of simplicity, the discussion here is only about a fertilizer spreader, a pneumatic fertilizer is thus also included.

It should be emphasized that the generation of the feed air flow and of the positive pressure by means of the flow-generating device can both take place simultaneously, preferably can take place during the operation of the fertilizer spreader, i.e. during the distribution of spreading material by means of the fertilizer spreader.

It is preferably provided that a positive pressure level is in each case present in the storage container and in the distribution lines; in particular, it is provided that no negative pressure whatsoever is generated in the storage container and in the distribution lines. With the positive pressure level preferably being greater than atmospheric pressure.

The distribution elements are formed in particular by impact elements, e.g. baffle plates. In particular, it is provided that the spreading material is conveyed towards the impact elements, or the baffle plates, by means of the feed air flow and is subsequently distributed over a wide area, preferably over the entire area, by means of resultantly generated spreading fans.

Particularly preferably, the metering device and the distribution elements are directly connected by means of the distribution lines, in particular without distribution heads or the like connected or arranged in between.

In a preferred embodiment of the fertilizer spreader according to the disclosure, the positive pressure is greater than or equal to the air pressure, generated by the feed air flow, in the distribution lines in the region of the metering device. Alternatively or additionally, a resulting pressure difference between the distribution lines and the storage container in the region of the metering device is smaller than 250 millibar or is smaller than 100 millibar or is smaller than 50 millibar or is essentially 0 bar. In particular, it is provided that there is no pressure difference, particularly preferably no pressure drop generated by negative pressure, between the storage container and the distribution lines.

Within the context of the disclosure, the definition “in the region of the metering device” comprises in particular the region in which the spreading material is transferred from the metering device into the distribution lines and/or the spreading material is transferred from the storage container into the metering device.

The flow-generating device is designed in particular to provide an air flow and/or an air pressure, in particular a positive air pressure. The feed air flow preferably results by means of the air flow and/or the air pressure and by means of the opening at the end of the distribution line. Particularly preferably, the positive pressure results by means of the air flow and/or the air pressure and by means of the pressure-tight design of the storage container.

The flow-generating device is formed in particular by a fan (e.g. centrifugal fan), which is operable at a variable rotational speed, or by two or more fans (e.g. centrifugal fans), which are each operable at a variable rotational speed. In particular, the feed air flow and/or the positive pressure can be subjected to open-loop and/or closed-loop control depending on the rotational speed. The rotational speed can be changed in particular by a motor which can be variably subjected to closed-loop and/or open-loop control by means of a control device. The motor can be formed, for example, by a hydraulic motor.

In order to provide an air pressure which is as identical as possible, in particular a possible identical feed air flow in all of the distribution lines, and in order to generate a greater positive pressure than atmospheric pressure in the storage container, for the respective connection, the flow-generating device is coupled in particular to an air flow divider device. In particular, the one or more, the flow-generating device, can therefore each be coupled to the air flow divider device, preferably can be coupled exclusively to the air flow divider device, in order therefore in turn to provide a substantially identical pressure level in all of the components.

The flow-generating device and/or the air flow divider device are/is preferably assigned, in particular spatially assigned, to the distributor boom, in particular to the central part of the distribution boom. A spatial assignment can be achieved, for example, by a constructional unit.

For the respective connection, the air flow divider device preferably has a multiplicity of connection ports. In particular, it can be provided that at least one pressure-equalizing connection is arranged for the respective connection between the air flow divider device and the storage container. The pressure-equalizing connection can be formed, for example, by a line connection.

Preferably, a plurality of connection lines having identical and/or different cross sections are arranged for the respective connection between the air flow divider device and the distribution lines. The connection lines can be formed, for example, by connecting branches. Alternatively or in addition, the connection lines can be formed by line portions.

On the basis of the connection lines which have an identical and/or different cross section, and the connection ports which have an identical and/or different cross section, the speed of the feed air flow can therefore be additionally variable.

In order in each case to achieve feed air flows which are as identical as possible (e.g. identical flow speeds) in the connection lines, it is also possible for the air flow divider device to have a substantially centre-symmetrical design.

In order to achieve the effect that the pressure difference is as small as possible, it is possible, according to a development of the disclosure, that a pressure-equalizing connection is provided between the storage container and the metering device and/or between the storage container and the distribution lines and/or between the metering device and the distribution lines, wherein the pressure-equalizing connection is formed in particular by a pressure-equalizing line and/or a pressure-equalizing channel. The pressure-equalizing connection is preferably formed by a pneumatic connection.

Particularly preferably, all of the components guiding spreading material or conveying spreading material (e.g. the storage container, metering device, distribution lines) of the fertilizer spreader are pneumatically connected to the flow-generating device, which in turn can preferably be achieved by one or more pressure-equalizing connections (e.g. pressure-equalizing lines) and/or can be achieved by the connection to the air flow divider device.

A preferred development of the fertilizer spreader can provide that the storage container and the metering device are assigned to the distributor boom, in particular to the central part of the distributor boom. Alternatively or in addition to this, it can be provided that the storage container and the metering device are assigned to the chassis. In turn, in an embodiment with two storage containers, the latter can be connected to a conveyor system which can likewise be subjected to a positive pressure. The conveyor system can be formed by one or more conveyor worms and/or by a pneumatic conveyor system and/or by one or more conveyor belts and/or the like. The conveyor system can in turn be used as a metering device for the storage container attached to the chassis. The storage container assigned to the chassis in particular has a storage container with a much larger volume than the storage container assigned to the distributor boom.

In order to achieve as efficient use as possible of the flow-generating device, it is possible, according to a development of the disclosure, that the flow-generating device, preferably the one or more fans forming the flow-generating device, can be subjected to open-loop and/or closed-loop control by means of a control device, wherein open-loop control and/or closed-loop control takes place on the basis of a manual operator input and/or a positive pressure and/or air pressure, detected by means of a sensor device, in the storage container and/or in at least one distribution line. The open-loop and/or closed-loop controllability can therefore make it possible to appropriately adapt the positive pressure and the feed air flow. In particular, a pressure sensor for detecting the positive pressure can be assigned to the storage container. Alternatively or in addition, the air flow divider device and/or at least one distribution line can be assigned a pressure sensor and/or flow sensor and/or the like in order to detect an air pressure and/or a flow speed. Particularly preferably, the sensor device and/or the control device can be designed to indirectly and/or directly detect a pressure difference between the storage container and at least one distribution line and, on the basis thereof, the flow-generating device can be correspondingly subjected to open-loop and/or closed-loop control.

It can preferably be provided that the control device is designed to interrupt metering of spreading material if the positive pressure drops below a defined and/or definable positive pressure and/or in the event of a pressure difference exceeding a threshold value, and/or to output a warning signal (e.g. graphically, acoustically and/or haptically) by means of a display device.

The control device has, for example, a computer unit, an on-board computer and/or the like and also comprises an open-loop and/or closed-loop control circuit, in particular a hydraulic and/or pneumatic and/or electric open-loop and/or closed-loop control circuit, wherein the open-loop and/or closed-loop control circuit is expediently designed for the hydraulic and/or pneumatic and/or electric transmission of signals and/or commands. Which transmission of signals and/or commands can also take place wirelessly (e.g. by means of WLAN). It should also be emphasized that the terms “open-loop control” and “closed-loop control” and “control device” can refer to electronic and/or pneumatic and/or hydraulic open-loop controllers or closed-loop controllers which, depending on the design, can perform open-loop control tasks and/or closed-loop control tasks. Even if the term “control” is used herein, it can equally usefully also include “closed-loop control”. Similarly, when the term “closed-loop control” is used, it can equally also include “open-loop control”.

The metering device is preferably formed by one or more cell rotors, which are operable at a variable rotational speed, and/or one or more rotary airlocks having a cam wheel. Alternatively, the metering device is formed by one or more worm metering means, which are operable at a variable rotational speed and have a conveyor worm. In particular, it can be provided that the number of rotary airlocks and/or conveyor worms is identical and/or corresponds to half the number of distribution lines.

According to a preferred embodiment of the disclosure, it is provided that the storage container has an inlet opening and an outlet opening, wherein the inlet opening is closable pressure-tightly by means of at least one cover element. In particular, it is possible that the storage container has one or more chambers, wherein the one or more chambers can be closable by means of one or more cover elements. In order to achieve sufficient sealing by means of the one or more cover element(s), it is also possible for the latter to be closable by means of an adjustment element, for example to be closable by means of a hydraulically operated adjustment element.

In order to detect a respective filling level and/or in order to calculate the amount of spreading material metered in each case by means of the metering device, it can be provided that the storage container is assigned a filling level measuring device, in particular in the form of a weighing system.

Particularly preferably, it can be provided that the one or more cover elements are closable by means of one or more hydraulically actuated adjustment elements (e.g. hydraulic cylinders) and that the one or more fans forming the flow-generating device are operable by means of a hydraulic motor. In particular, in such an embodiment, it can be provided that the adjustment elements and the hydraulic motors are arranged in series and are therefore activated jointly, in particular depending on one another, in particular are activated in such a way by means of the control device.

A particularly preferred embodiment of the fertilizer spreader according to the disclosure makes provision in particular that the storage container is closable at least substantially pressure-tightly, in particular is closable pressure-tightly by means of one or more cover elements and/or that the connection between the storage container and the metering device is formed at least substantially pressure-tightly, and/or that the connection between the metering device and the distribution lines is formed at least substantially pressure-tightly.

In order to provide a pressure-tight storage container, it can be provided in particular that the outer walls thereof are welded and/or assembled pressure-tightly. Preferably, it is possible that openings which are present on the storage container are provided by means of corresponding seals, coverings with seals and/or the like.

According to a further aspect of the disclosure, a method for spreading granular agricultural spreading material on agricultural productive land with a pneumatic fertilizer spreader having a chassis and a distributor boom is provided.

The pneumatic fertilizer spreader is preferably designed according to at least one of the above-described embodiments. With regard to the advantages and embodiment variants of the method according to the disclosure, reference is therefore also made to the advantages and embodiment variants of the pneumatic fertilizer spreader according to the disclosure; in particular, it should be emphasized that the embodiments according to the disclosure and features are combinable in any desired way and freely with the pneumatic fertilizer spreader and/or the method. Accordingly, all of the embodiments and features according to the disclosure both for the pneumatic fertilizer spreader and for the method are disclosed and claimable.

The method comprises metering a defined amount of spreading material from a storage container into a plurality of distribution lines attached to the distributor boom. In addition, the method comprises transporting the metered spreading material along the distribution lines by means of a feed air flow generated in the distribution lines by means of a flow-generating device.

The method according to the disclosure also comprises the step of generating a greater positive pressure than atmospheric pressure in the storage container by means of the flow-generating device, in particular a positive pressure in the storage container that is greater than or equal to the air pressure generated by the feed air flow in the distribution lines in the region of the metering device.

Further details and advantages of the disclosure will be described below with reference to the attached drawings. The proportions of the individual elements with respect to one another in the figures do not always correspond to the real proportions, since some shapes simplified and other shapes are shown on an enlarged scale in comparison with other elements for improved illustration.

### BRIEF DESCRIPTION OF THE DRAWINGS

FIG. 1 shows a perspective view of an embodiment variant of a pneumatic fertilizer spreader with a distributor boom, in an unfolded working position.

FIGS. 2A and 2B show perspective views of the storage container, the metering device, the central part of the boom and the flow-generating device, as are used in the fertilizer spreader according to FIG. 1.

FIG. 3 shows a schematic diagram of an embodiment variant of a pneumatic fertilizer spreader according to the disclosure.

### DETAILED DESCRIPTION OF THE DRAWINGS

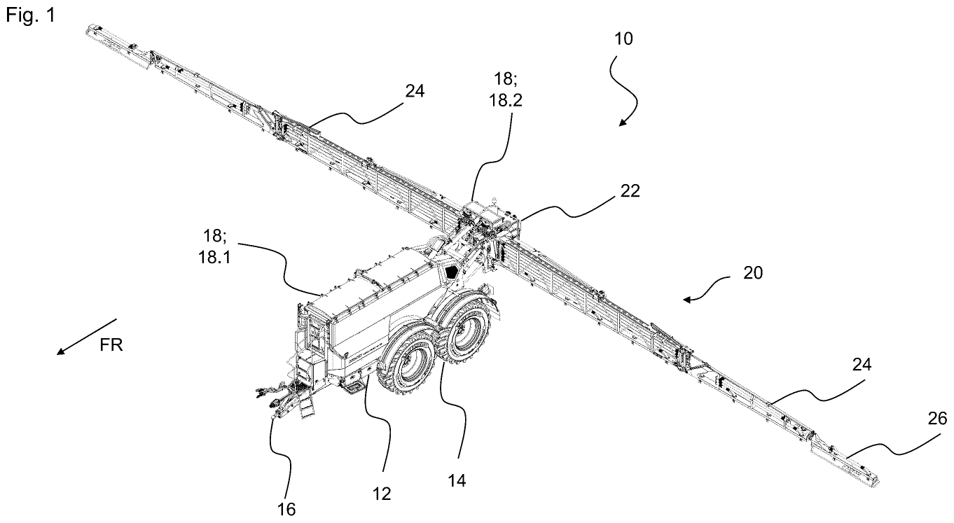

The embodiment variants shown in FIGS. 1 to 3 at least partially correspond, and therefore similar or identical parts are provided with the same reference signs and, for the explanation thereof, reference is also made to the description of the other embodiments or figures, in order to avoid repetitions.

FIG. 1 shows a perspective view of an embodiment variant of a pneumatic fertilizer spreader 10. The fertilizer spreader 10 is used to spread granular agricultural spreading material, e.g. granular fertilizer, on agricultural productive land.

The fertilizer spreader 10 comprises a chassis 12 carrying components of the fertilizer spreader 10, which chassis 12 is preferably formed by a frame construction. In addition, the chassis 12 has attached to it a running gear 14, for moving the fertilizer spreader 10, and a drawbar eye 16, for connecting the fertilizer spreader 10 to a towing vehicle, not illustrated here.

In order to carry along and provide the respective spreading material, the chassis 12 is also assigned a storage container 18, in particular a first storage container 18.1. The storage container 18 in FIG. 1 is also closed pressure-tightly by means of two cover elements.

In order to achieve as large an impact force as possible with distribution of the spreading material simultaneously as precisely as possible, the fertilizer spreader 10, on its rear side, comprises a distributor boom 20, which extends transversely to the direction of travel FR and is mounted height-adjustably on the chassis 12. The distributor boom 20 comprises a central part 22 and side arms 24 pivotably mounted on the central part 22. By means of the pivotability of the side arms 24, it is therefore possible to pivot the distributor boom 20 into a working position (see FIG. 1) and a transport position, in which the width is substantially reduced. The side arms 24 can be formed integrally or can be composed of two or more segments which, in turn, can be pivotable with respect to one another.

A plurality of distribution lines 26 with distribution elements 28 arranged at the ends are attached to the distributor boom 20. The distribution lines 26 each extend to different lengths starting from the central part 22 along the side arms 24. The distribution elements 28 are each attached at regular distances to the distribution boom 20 and are preferably designed as impact elements.

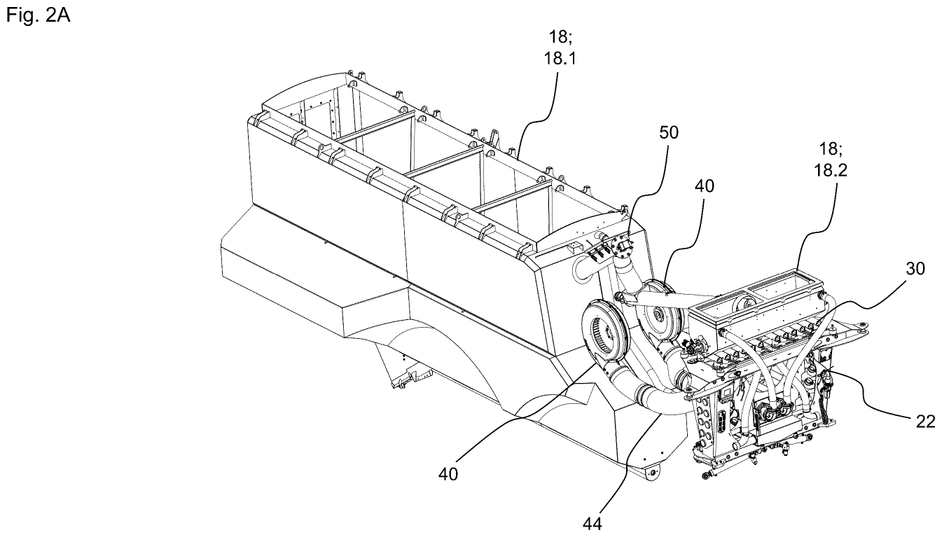

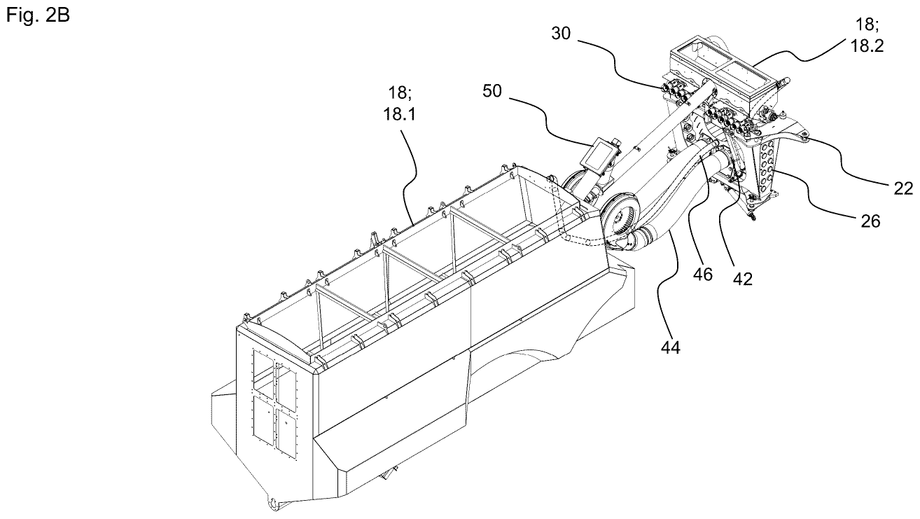

Further details of the disclosure emerge from the perspective views of FIGS. 2A & 2B, said figures showing a design of the fertilizer spreader 10 as used in the fertilizer spreader 10 according to FIG. 1.

FIGS. 2A & 2B each show the central part 22 of the distributor boom 20. The central part 22 is assigned a storage container 18, in particular a second storage container 18.2. The storage container 18, preferably the second storage container 18.2, is assigned a metering device 30 on the bottom side for metering a defined or definable amount of spreading material out of the storage container 18; 18.2. The metering device 30 is preferably formed by a plurality of conveyor worms, each operable at a variable rotational speed, wherein each conveyor worm is coupled in each case to a drive motor in order to influence the rotational speed.

The second storage container 18.2 has a substantially smaller volume than the first; for example, the first storage container 18.1 has a volume of at least 3000 litres; 5000 litres or more, and the second storage container 18.2 has, for example, a volume of at least 200 litres, 500 litres or more.

The central part 22 is arranged on a rear side of a storage container 18, preferably the first storage container 18.1. The storage containers 18, i.e. the first storage container 18.1 and the second storage container 18.2, are coupled by means of a conveyor device 50 in such a way that the respective spreading material can be conveyed from the first storage container 18.1 into the second storage container 18.2. That is to say, the second storage container 18.2 is supplied in particular from the first storage container 18.1. The conveyor device 50 is formed by a plurality of conveyor worms, but, alternatively or in addition, could also be formed by just one conveyor worm and/or by a pneumatic conveyor system and/or the like.

In addition, the fertilizer spreader 10 comprises a flow-generating device 40 which is designed to provide an air flow and/or an air pressure (e.g. positive pressure). The flow-generating device 40 is formed by two fans, each operable at a variable rotational speed. In order to generate a feed air flow in a multiplicity of distribution lines 26 by means of the flow-generating device 40, the latter is also connected by means of connecting lines 44 to an air flow divider device 42.

The air flow divider device 42 is assigned in particular to the central part 22 of the distribution boom 20.

For the connection to the respective distribution lines 26, the air flow divider device 42 comprises a multiplicity of connection ports 48.

In order also to generate a greater positive pressure than atmospheric pressure in the storage container 18, a pressure-equalizing connection 46 is also provided between the air flow divider device 42 and the storage container 18. The pressure-equalizing connection 46 is formed by a pressure-equalizing line.

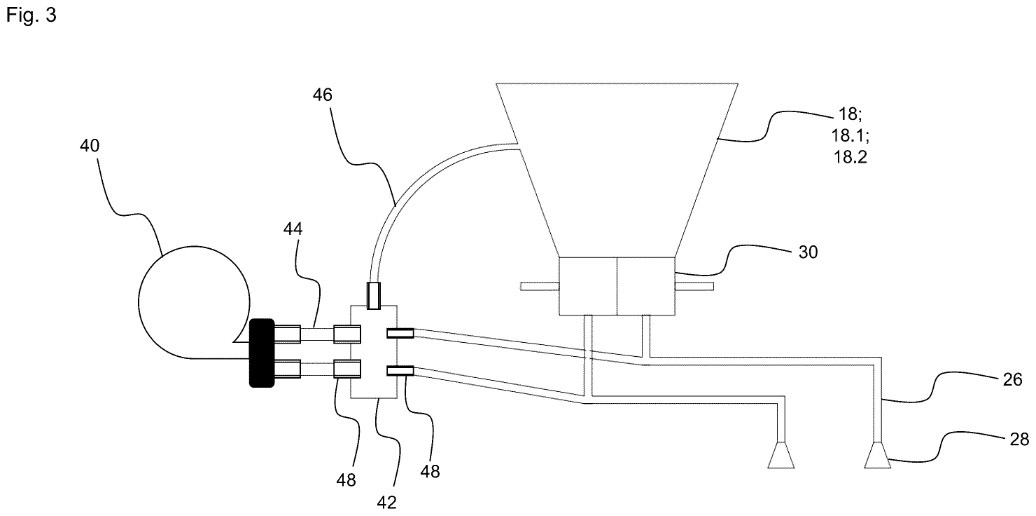

FIG. 3 shows a schematic diagram of an embodiment variant of a pneumatic fertilizer spreader 10 according to the disclosure. The diagram shows a storage container 18, at the lower end of which a metering device 30, which is designed for metering a defined amount of spreading material out of the storage container 18 into distributing lines 26, is arranged. In addition, a distribution element 28 is attached to the respective end of the distribution lines 26.

In order to generate a feed air flow in the distribution lines 26, to convey and to transport the spreading material along the distribution lines 26, and to generate a greater positive pressure than atmospheric pressure in the storage container 18, a flow-generating device 40 is also provided.

The positive pressure in the storage container 18 is preferably greater than or equal to the air pressure generated by the feed air flow in the distribution lines 26 in the region of the metering device 30. In particular, the resulting pressure difference between the distribution lines 26 and the storage container 18 in the region of the metering device 30 is smaller than 250 millibar or is smaller than 100 millibar or is smaller than 50 millibar or is essentially 0 bar.

The flow-generating device 40 is coupled to an air flow divider device 42. The air flow divider device 42 comprises a multiplicity of connection ports 48 having identical and different cross sections (e.g. cross-sectional areas).

In addition, in order to achieve as small a pressure difference as possible, a pressure-equalizing connection 46 is arranged between the air flow divider device 42 and the storage container 18.

### LIST OF REFERENCE SIGNS

10 pneumatic fertilizer spreader
12 chassis
14 running gear
16 drawbar eye
18 storage container
18.1 first storage container
18.2 second storage container
20 distributor boom
22 central part
24 side arm
26 distribution line
28 distribution element
30 metering device
40 flow-generating device
42 air flow divider device
44 connecting line
46 pressure-equalizing connection
48 connection port
FR direction of travel

Although the disclosure has been described with reference to certain exemplary embodiments, it is apparent to a person skilled in the art that various changes can be made and equivalents can be used instead, without departing from the scope of the disclosure. In addition, many modifications can be carried out without departing from the associated scope. Consequently, the disclosure is not intended to be limited to the disclosed exemplary embodiments, but rather is intended to comprise all exemplary embodiments which are covered within the scope of the appended claims. In particular, the disclosure also claims protection for the subject matter and the features of the dependent claims irrespective of the claims to which reference is made.

What is claimed is:

1. A pneumatic fertilizer spreader for spreading granular agricultural spreading material on agricultural productive land, comprising
a chassis carrying components of the fertilizer spreader;
a distributor boom, which extends transversely to the direction of travel (FR) and is mounted height-adjustably on the chassis, wherein the distributor boom has a central part and side arms pivotably mounted on the central part, and wherein a plurality of distribution lines with distribution elements are attached to the distributor boom;
a metering device, which is designed for metering a defined quantity of spreading material from a storage container into the distribution lines; and
a flow-generating device,
wherein the flow-generating device is designed to generate, by means of a respective connection,
a feed air flow in the distribution lines for transporting the spreading material along the distribution lines, and
a greater positive pressure than atmospheric pressure in the storage container.

2. The fertilizer spreader according to claim 1, wherein
the positive pressure is greater than or equal to the air pressure, generated by the feed air flow, in the distribution lines in the region of the metering device, and/or
a resulting pressure difference between the distribution lines and the storage container in the region of the metering device is smaller than 250 millibar or is smaller than 100 millibar or is smaller than 50 millibar or is essentially 0 bar.

3. The fertilizer spreader according to claim 1, wherein
the flow-generating device is designed to provide an air flow and/or an air pressure, and/or
the flow-generating device is formed by a fan, which is operable at a variable rotational speed, or by two or more fans, which are each operable at a variable rotational speed, and/or
for the respective connection, the flow-generating device is coupled to an air flow divider device.

4. The fertilizer spreader according to claim 3, wherein the flow-generating device and/or the air flow divider device are/is assigned to the central part of the distribution boom.

5. The fertilizer spreader according to claim 3, wherein
for the respective connection, the air flow divider device has a multiplicity of connection ports, and/or
at least one pressure-equalizing connection is arranged for the respective connection between the air flow divider device and the storage container, and/or
a plurality of connection lines having identical and/or different cross sections are arranged for the respective connection between the air flow divider device and the distribution lines.

6. The fertilizer spreader according to claim 3, wherein
a pressure-equalizing connection is provided between the storage container and the distribution device and/or
between the storage container and the distribution lines and/or
between the metering device and the distribution lines,
wherein the pressure-equalizing connection is formed by a pressure-equalizing line and/or a pressure-equalizing channel.

7. The fertilizer spreader according to claim 1, wherein
the storage container and the metering device are assigned to the central part of the distributor boom, and/or
the storage container and the metering device are assigned to the chassis.

8. The fertilizer spreader according to claim 1, wherein the flow-generating device can be subjected to open-loop and/or closed-loop control by means of a control device, wherein open-loop control and/or closed-loop control takes place by
a manual operator input and/or
on the basis of a positive pressure and/or air pressure, detected by means of a sensor device, in the storage container and/or in at least one distribution line.

9. The fertilizer spreader according to claim 1, wherein the metering device is formed by
one or more cell rotors, which are operable at a variable rotational speed, and/or rotary airlocks having a cam wheel, and/or
one or more worm metering means, which are operable at a variable rotational speed and have conveyor worms.

10. The fertilizer spreader according to claim 1, wherein the storage container is closable at least substantially pressure-tightly, and/or in that the connection between the storage container and the metering device is formed at least substantially pressure-tightly, and/or in that the connection between the metering device and the distribution lines is formed at least substantially pressure-tightly.

11. A method for spreading granular agricultural spreading material on agricultural productive land with a pneumatic fertilizer spreader having a chassis and a distributor boom according to claim 1, comprising the steps of
metering a defined amount of spreading material from a storage container into a plurality of distribution lines attached to the distributor boom,
transporting the metered spreading material along the distribution lines by a feed air flow generated in the distribution lines by a flow-generating device, and
generating a greater positive pressure than atmospheric pressure in the storage container by means of the flow-generating device and a positive pressure in the storage container that is greater than or equal to the air pressure generated by the feed air flow in the distribution lines in the region of the metering device.
